(19) United States
(12) Patent Application Publication
(10) Pub. No.: US 2020/0201398 A1
(43) Pub. Date: Jun. 25, 2020

(54) Professional portable device for information processing exchange

(71) Applicant: Yikai Chen, Binzhou City (CN)

(72) Inventor: Yikai Chen, Binzhou City (CN)

(21) Appl. No.: 16/805,823

(22) Filed: Mar. 1, 2020

(30) Foreign Application Priority Data
Nov. 19, 2019 (CN) 2019111367464

(51) Int. Cl. G06F 1/16; G11B 33/04; G11B 33/12; G06F 1/20

(52) U.S. Cl. CPC G06F 1/1656; G11B 33/0405; G11B 33/122; G06F 1/1616; G06F 1/1662; G06F 1/203; G11B 33/124

(57) ABSTRACT

The invention discloses a professional portable device for information processing exchange, which includes a main box body. A rectangular frame is slidably arranged on the top surface of the main box body. A storage cavity is provided on the top surface of the rectangular frame. A long chute is provided between the front and rear walls of the storage cavity, and a pin is slidably disposed between the two sets of the long chute. A display frame is provided in the storage cavity, and the pin passes through one end of the display frame. The display of the present invention can be stored in the storage cavity. At the same time, the height of the rectangular frame can be adjusted to adjust the height of the display, so that the operator can adjust the height according to the actual situation, which makes it more comfortable to use. The slot allows the U disk to be stored in the bottom slot together with the U disk processor to prevent the U disk from being lost. Furthermore, the invention is portable and very portable.

### CROSS-REFERENCES TO RELATED APPLICATIONS

The present application claims priority from Chinese application No. 2019111367464 filed on Sep. 19, 2019 which is hereby incorporated by reference in its entirety.

### TECHNICAL FIELD

The invention relates to the field of information processing technology, and in particular to a professional portable device for information processing exchange.

### BACKGROUND OF THE INVENTION

Information exchange equipment generally includes computers, mobile phones and U disks that can input and output data. Traditional computers or notebooks are not convenient to use in special occasions, such as professional encryption equipment, which is inconvenient to use in specific occasions, so it is necessary Design a professional portable information processing and exchange equipment, easy to carry and use.

### BRIEF SUMMARY OF THE INVENTION

An object of the present invention is to provide a professional portable device for information processing exchange, which is used to overcome the above-mentioned defects in the prior art.

A professional portable device for information processing exchange according to the present invention includes a main box body, and a rectangular frame is slidably arranged on the top surface of the main box body. A storage cavity is provided on the top surface of the rectangular frame. A long chute is provided between the front and rear walls of the storage cavity, and a pin is slidably disposed between the two sets of the long chute. A display frame is provided in the storage cavity, and the pin passes through one end of the display frame. And the display frame is fixedly connected to the pin, a display is fixed on the top surface of the display frame, the display can display information, and the display can swing out of the office by the display frame A processor cavity is provided on the bottom surface of the main box, and a processor is slidably disposed in the processor cavity, and the processor can input electric signals to the display. The left side of the processor cavity is in communication with the outside world. Heat dissipation plates are fixed in the left and right side walls of the processor cavity. A fan cavity is provided on the right side of the processor cavity, and the fan cavity rotates. Equipped with a fan, which can The processor blows air to dissipate heat. A bottom slot is formed on the right side of the main box, and a U disk processor is slidably arranged in the bottom slot. Two sets of U disk interfaces. The U disk interfaces can read external U disk information, and the top of the main box is provided with a keyboard.

In addition, in one of the embodiments, the left and right sides of the rectangular frame are provided with slide grooves, and a thread block is slidably arranged in the slide groove, and the thread block is fixed to the rectangular frame, and the slide groove A threaded rod is provided for rotation inside, and the threaded rod is threadedly connected to the threaded block. The bottom extensions of the two groups of threaded rods are connected by a belt. The lifting motor embedded in the main box is connected by power.

In addition, in one embodiment, a power motor is embedded in the left wall of the storage cavity, a right-handed spiral rod is connected to the right end of the power motor, and a bottom wall of the storage cavity is provided. A bottom groove, in which a slider is slidably provided, a threaded slider is threadably connected to the screw rod, and a connecting rod is fixed between the threaded slider and the slider, and the threaded slider A hinge rod is hinged with the bottom surface of the display frame.

In addition, in one of the embodiments, the bottom of the processor cavity can be opened, a conductive plate is fixed on the top wall of the processor cavity, and an electrical connection block is fixed on the top surface of the processor. The connection block can be inserted into the conductive plate, and the conductive plate is electrically connected to the display. A card plate is slidably arranged on the right wall of the processor cavity, and the card plate can block the processor. A first spring is installed between the clamping plate and the main box.

In addition, in one embodiment, a heat sink motor is embedded in the right wall of the fan cavity, the heat sink motor is dynamically connected to the fan, and an opening is provided at the bottom of the fan cavity.

In addition, in one embodiment, a right side of the bottom groove is provided with a rotating baffle that can close the bottom groove, and the U disk processor is installed between the left side wall of the bottom groove There is a second spring, and a conductive contact is fixed on the top wall of the bottom slot. The conductive contact is electrically connected to the conductive plate. The conductive contact can connect the electric power in the U disk processor. The signal is transmitted to the processor.

In addition, in one embodiment, a rack that can limit the U disk processor is slidably disposed on the bottom wall of the bottom slot, and a reset mechanism is fixed on the left side of the rack, and the tooth A gear is engaged on the front side of the bar, a knob is fixedly connected to the right end of the gear, a slot is opened on the bottom surface of the U disk processor, and the rack can be inserted into the slot.

The beneficial effect of the present invention is that the display of the present invention can be stored in the storage cavity, and the height of the rectangular frame can be adjusted by lifting the rectangular frame, so that the operator can adjust the height according to the actual situation, so that it is more comfortable to use, and the U disk processor Can be stored and slide out of the bottom slot, so that the U disk can be stored in the bottom slot together with the U disk processor to prevent the U disk from being lost, and the invention is portable, very portable, and the entire device structure is relatively simple, and the operation is relatively simple Convenient and easy to promote.

### BRIEF DESCRIPTION OF THE DRAWINGS

FIG. 1 is a schematic diagram of the overall internal structure of a professional portable device for information processing exchange according to the present invention;

FIG. 2 is a partially enlarged schematic view of A in FIG. 1 of the present invention; FIG.

FIG. 3 is a schematic diagram of the appearance of a professional portable for information processing exchange according to the present invention.

### DETAILED DESCRIPTION OF THE INVENTION

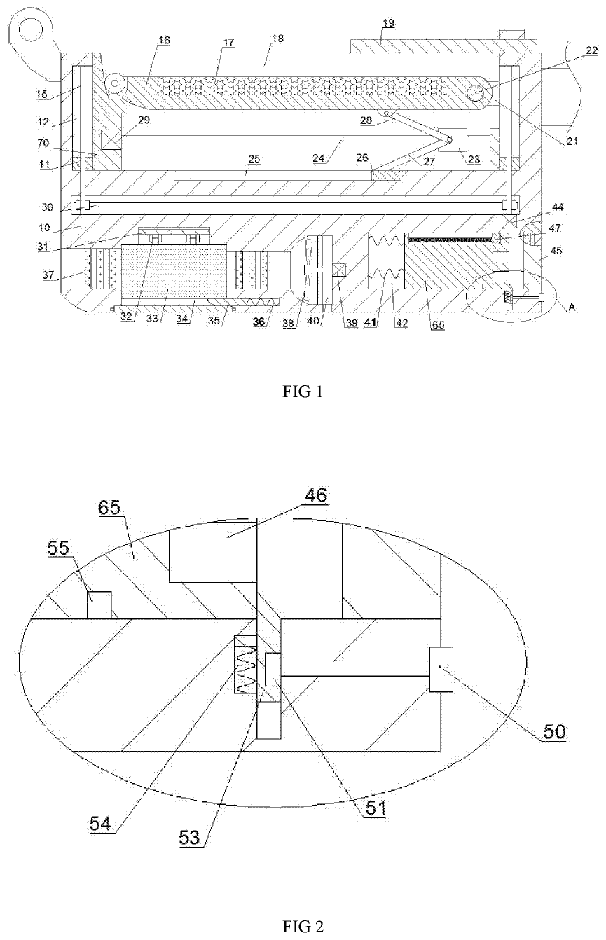

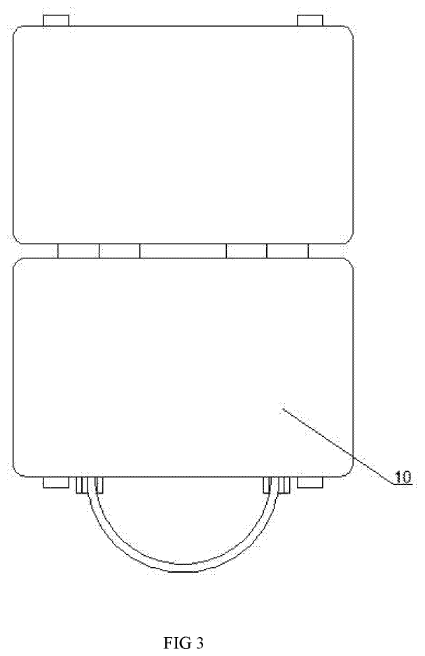

The present invention will be described in detail below with reference to FIGS. 1-3. For convenience of description, the orientations described below are defined as follows: the up-down, left-right, front-back direction described below is consistent with the up-down, left-right, front-back direction of the projection relationship of FIG. 1 itself.

Referring to FIGS. 1-3, a professional portable device for information processing exchange according to an embodiment of the present invention includes a main cabinet 10, and a rectangular frame 70 is slidably arranged on the top surface of the main cabinet 10. A storage cavity 18 is provided on the top surface of the frame 70, and a long chute 21 is provided between the front and rear walls of the storage cavity 18, and a pin 22 is slid between the two sets of the long chute 21, and the storage A display frame 16 is provided in the cavity 18, the pin shaft 22 penetrates one end of the display frame 16, and the display frame 16 is fixedly connected to the pin shaft 22, and the top surface of the display frame 16 is fixedly embedded in the display frame 16. The display 17 can display information. The display 17 can swing out of the storage cavity 18 under the drive of the display frame 16 for the operator to read the information. The bottom surface of the main cabinet 10 A processor cavity 34 is provided on the upper side, and a processor 33 is slidably disposed in the processor cavity 34. The processor 33 can input electrical signals to the display 17. The left side of the processor cavity 34 is in communication with the outside world. Heat dissipation plates 37 are fixed in the left and right side walls of the processor cavity 34, and the processor cavity 3 4 is provided with a fan cavity 40 on the right side, and a fan 38 is rotatably provided in the fan cavity 40. The fan 38 can blow air to the processor 33 for heat dissipation, and a right side surface of the main cabinet 10 is provided. Bottom slot 42, a U disk processor 65 is slidably arranged in the bottom slot 42, two sets of U disk interfaces 46 are fixed on the right side of the U disk processor 65, and the U disk interfaces 46 can be read External U disk information, a keyboard 19 is slid on the top of the main box 10.

Preferably or exemplarily, the left and right sides of the rectangular frame 70 are provided with chute grooves 12, and a thread block 11 is slidably arranged in the chute 12, and the thread block 11 is fixed to the rectangular frame 70. A threaded rod 15 is rotatably provided in each of the chute 12, and the threaded rod 15 and the threaded block 11 are screwed together. The bottom extensions of the two groups of threaded rods 15 are connected by a belt 30 and are located on the right side. The bottom end of the threaded rod 15 is power-connected to a lifting motor 44 which is fixedly embedded in the main casing 10. By the operation of the lifting motor 44, the threaded rod 15 is rotated and the rectangular frame is further turned. 70 slide up for easy height adjustment.

Beneficially or exemplarily, a power motor 29 is fixedly embedded in the left wall of the storage cavity 18, and a right-handed screw rod 24 is connected to the right end of the power motor 29. The bottom wall of the storage cavity 18 is A bottom groove 25 is provided on the bottom, and a slider 26 is slidably arranged in the bottom groove 25. A threaded slider 23 is screw-fitted on the screw rod 24, and the threaded slider 23 is fixed to the slider 26. A connecting rod 27 is provided, and a hinged rod 28 is hinged between the threaded slider 23 and the bottom surface of the display frame 16. The power motor 29 works to rotate the spiral rod 24, thereby sliding the thread. The block 23 slides, so that the display frame 16 swings out of the storage cavity 18.

Beneficially or exemplarily, the bottom of the processor cavity 34 can be opened, a conductive plate 31 is fixed on the top wall of the processor cavity 34, and an electrical connection block is fixed on the top surface of the processor 33. 32. The power connection block 32 can be inserted into the conductive plate 31. The conductive plate 31 is electrically connected to the display 17. The right wall of the processor cavity 34 is provided with a card plate 35. The card board 35 can block the processor 33, and a first spring 36 is installed between the card board 35 and the main box 10. By pushing the processor 33 into the processor cavity 34, The card board 35 catches the processor 33.

Beneficially or exemplarily, a heat dissipation motor 39 is embedded in the right wall of the fan cavity 40, and the heat dissipation motor 39 is dynamically connected to the fan 38. The bottom of the fan cavity 40 is provided with an opening through which The heat-dissipating motor 39 is operated to rotate the fan 38, and to blow the processor 33 and the heat-dissipating plate 37, so that the processor 33 can cool down.

Beneficially or exemplarily, the right side of the bottom groove 42 is provided with a rotating baffle 45 that can close the bottom groove 42, and the U disk processor 65 and the left side wall of the bottom groove 42. A second spring 41 is installed between them. A conductive contact 47 is fixed on the top wall of the bottom groove 42. The conductive contact 47 is electrically connected to the conductive plate 31. The conductive contact 47 can The electric signals in the U-disk processor 65 are transmitted to the processor 33.

Advantageously or exemplarily, a rack 53 that can limit the U disk processor 65 is slidably disposed on the bottom wall of the bottom groove 42, and a reset mechanism 54 is fixed on the left side of the rack 53. A gear 51 is engaged on the front side of the rack 53. A knob 50 is fixedly connected to the right end of the gear 51. A slot 55 is provided on the bottom surface of the U disk processor 65. The rack 53 can be inserted into the rack 51. Describes inside the slot 55.

When using, if you need to use the display 17, first slide the keyboard 19 to the right, then control the lift motor 44 to work, make the threaded rod 15 rotate, and then make the threaded block 11 slide up, so that the rectangular frame 70 slides upward, and then through the control The power motor 29 works to rotate the screw rod 24, and then slide the pin 22 to the left, so that the left part of the display frame 16 is rotated out of the storage cavity 18, and then the information is input by the keyboard 19 to cause the processor 33 Work, and then cause the processor 33 to transmit information to the display 17, and at the same time control the heat dissipation motor 39 to rotate the fan 38, so that the fan 38 blows air to the processor 33 and the heat sink 37, so that the processor 33 can dissipate heat To remove the processor 33, simply push the card board 35 to the right and manually remove the processor 33;

If you need to read the data of the U disk, first open the turning baffle 45, and then turn the knob 50 to move the rack 53 down. At this time, the U disk processor 65 will be ejected under the elastic force of the second spring 41. Release the knob 50. The rack 53 is reset by the reset mechanism 54, the rack 53 is inserted into the slot 55, the U disk processor 65 is limited, and then the U disk is inserted into the U disk interface 46 for data processing.

The beneficial effect of the present invention is that the display of the present invention can be stored in the storage cavity, and the height of the rectangular frame can be adjusted by lifting the rectangular frame, so that the operator can adjust the height according to the actual situation, so that it is more comfortable to use, and the U disk processor Can be stored and slide out of the bottom slot, so that the U disk can be stored in the bottom slot together with the U disk processor to prevent the U disk from being lost, and the invention is portable, very portable, and the entire device structure is relatively simple, and the operation is relatively simple Convenient and easy to promote.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. A professional portable device for information processing exchange, comprising a main box, characterized in that a rectangular frame is slidably arranged on the top surface of the main box, and a storage cavity is provided on the top surface of the rectangular frame, A long chute is provided between the front and rear walls of the storage cavity, and a pin is slidably disposed between the two groups of the long chute. A display frame is provided in the storage cavity, and the pin passes through the display frame The display frame is fixedly connected to the pin, a display is embedded on the top surface of the display frame, the display can display information, and the display can swing and slide under the drive of the display frame Out of the storage cavity for the operator to read information, a processor cavity is provided on the bottom surface of the main box, and a processor is slidably disposed in the processor cavity, and the processor can input to the display Electrical signals, the left side of the processor cavity is in communication with the outside, heat dissipation plates are fixed in the left and right side walls of the processor cavity, and a fan cavity is provided on the right side of the processor cavity. The fan cavity Inside, there is a fan, which can be The processor is blown to the processor for heat dissipation. A bottom slot is provided on the right side of the main box, and a U disk processor is slidably arranged in the bottom slot. The U disk processor is fixed on the right side. There are two sets of U disk interfaces. The U disk interfaces can read external U disk information. The top of the main box is provided with a keyboard.

2. A professional portable device for information processing exchange according to claim 1, characterized in that: the left and right sides of the rectangular frame are provided with slide grooves, and thread blocks are slidably provided in the slide grooves, The thread block is fixed to the rectangular frame, and a threaded rod is rotatably provided in the chute. The threaded rod and the thread block are threadedly connected. The bottom extensions of the two groups of threaded rods are connected by a belt. It is connected, and the bottom end of the threaded rod on the right side is power-connected with a lifting motor embedded in the main box.

3. The professional portable device for information processing exchange according to claim 2, characterized in that: a power motor is fixedly embedded in the left wall of the storage cavity, and the right end of the power motor is power-connected to the right An extended spiral rod is provided with a bottom groove on the bottom wall of the storage cavity, and a slider is slidably arranged in the bottom groove. A threaded slider is threadedly connected to the spiral rod, and the threaded slider and the A connecting rod is fixed between the sliders, and a hinge rod is hinged between the threaded slider and the bottom surface of the display frame.

4. The professional portable device for information processing exchange according to claim 3, characterized in that: the bottom of the processor cavity can be opened, and a conductive plate is fixed on the top wall of the processor cavity. A power connection block is fixed on the top surface of the processor, the power connection block can be inserted into the conductive plate, the conductive plate is electrically connected to the display, and a right side wall of the processor cavity is slidably provided. There is a card board, which can block the processor, and a first spring is installed between the card board and the main box.

5. The professional portable device for information processing exchange according to claim 4, characterized in that: a cooling motor is fixedly embedded in the right wall of the fan cavity, and the cooling motor is dynamically connected to the fan, so that The bottom of the fan cavity is provided with an opening.

6. The professional portable device for information processing exchange according to claim 5, characterized in that: a rotation baffle capable of closing the bottom groove is provided on the right side of the bottom groove, and the U A second spring is installed between the disk processor and the left side wall of the bottom slot. A conductive contact is fixed on the top wall of the bottom slot, and the conductive contact is electrically connected to the conductive plate. The conductive contacts can conduct electrical signals in the U-disk processor to the processor.

7. The professional portable device for information processing exchange according to claim 6, characterized in that: a rack which can limit the U disk processor is slidably arranged on the bottom wall of the bottom groove, and the tooth A reset mechanism is fixed on the left side of the bar, a gear is engaged on the front side of the rack, a knob is fixedly connected to the right end of the gear, a slot is opened on the bottom surface of the U disk processor, and the rack Can be inserted into the slot.
